(19) United States
(12) Patent Application Publication
(10) Pub. No.: US 2014/0114534 A1
(43) Pub. Date: Apr. 24, 2014

(54) DYNAMIC REARVIEW MIRROR DISPLAY FEATURES

(71) Applicant: GM GLOBAL TECHNOLOGY OPERATIONS LLC, DETROIT, MI (US)

(72) Inventors: Wende Zhang, Troy, MI (US); Jinsong Wang, Troy, MI (US); Kent S. Lybecker, St. Clair Shores, MI (US); Jeffrey S. Piasecki, Rochester, MI (US); James Clem, Lapeer, MI (US); Charles A. Green, Canton, MI (US); Ryan M. Frakes, Bloomfield Hills, MI (US); Travis S. Hester, Rochester Hills, MI (US)

(73) Assignee: GM GLOBAL TECHNOLOGY OPERATIONS LLC, DETROIT, MI (US)

(21) Appl. No.: 13/835,741

(22) Filed: Mar. 15, 2013

Related U.S. Application Data
(60) Provisional application No. 61/715,946, filed on Oct. 19, 2012.

(51) Int. Cl. B60R 1/02

(52) U.S. Cl. CPC B60R 1/02
USPC 701/42; 701/36

(57) ABSTRACT

A method for displaying a captured image on a display device. A scene is captured by at least one vision-based imaging device. A virtual image of the captured scene is generated by a processor using a camera model. A view synthesis technique is applied to the captured image by the processor for generating a de-warped virtual image. A dynamic rearview mirror display mode is actuated for enabling a viewing mode of the de-warped image on the rearview mirror display device. The de-warped image is displayed in the enabled viewing mode on the rearview mirror display device.

### CROSS-REFERENCE TO RELATED APPLICATIONS

This application claims priority of U.S. Provisional Application Ser. No. 61/715,946 filed Oct. 19, 2012, the disclosure of which is incorporated by reference.

### BACKGROUND OF INVENTION

An embodiment relates generally to image capture and processing for dynamic rearview mirror display features.

Vehicle systems often use in-vehicle vision systems for rear-view scene detections, side-view scene detection, and forward view scene detection. For those applications that require graphic overlay or to emphasize an area of the captured image, it is critical to accurately calibrate the position and orientation of the camera with respect to the vehicle and the surrounding objects. Camera modeling which takes a captured input image from a device and remodels the image to show or enhance a respective region of the captured image must reorient all objects within the image without distorting the image so much that it becomes unusable or inaccurate to the person viewing the reproduced image.

When a view is reproduced in a display screen, an overlap of images becomes an issue. Views captured from different capture devices and integrated on the display screen typically illustrate abrupt segments between each of the captured images thereby making it difficult for a driver to quickly ascertain what is being presented in the display screen.

### SUMMARY OF INVENTION

An advantage of the invention described herein is that an image can be synthesized using various image effects utilizing a camera view synthesis based on images captured by one or multiple cameras. The image effects include capturing various images by multiple cameras where each camera captures a different view around the vehicle. The various images can be stitched for generating a seamless panoramic image. Common points of interest are identified for registering point pairs in the overlapping region of the captured images for adjoining adjacent image views.

Another advantage of the invention is the dynamic reconfigurable mirror display system can cycle through and display the various images captured by the plurality of imaging display devices. Images displayed on the rearview display device may be selected autonomously based on a vehicle operation or may be selected by a driver of the vehicle.

A method for displaying a captured or processed image on a display device. A scene is captured by at least one vision-based imaging device. A virtual image of the captured scene is generated by a processor using a camera model. A view synthesis technique is applied to the captured image by the processor for generating a de-warped virtual image. A dynamic rearview mirror display mode is actuated for enabling a viewing mode of the de-warped image on the rearview mirror display device. The de-warped image is displayed in the enabled viewing mode on the rearview mirror display device.

### BRIEF DESCRIPTION OF DRAWINGS

FIG. 1 is an illustration of a vehicle including a surround view vision-based imaging system.

FIG. 2 is a top view illustration showing the coverage zones for the vision-based imaging system.

FIG. 3 is an illustration of a planar radial distortion virtual model.

FIG. 4 is an illustration of a non-planar pin-hole camera model.

FIG. 5 is a block flow diagram utilizing cylinder image surface modeling.

FIG. 6 is a block flow diagram utilizing an ellipse image surface model.

FIG. 7 is a flow diagram of view synthesis for mapping a point from a real image to the virtual image.

FIG. 8 is an illustration of a radial distortion correction model.

FIG. 9 is an illustration of a severe radial distortion model.

FIG. 10 is a block diagram for applying view synthesis for determining a virtual incident ray angle based on a point on a virtual image.

FIG. 11 is an illustration of an incident ray projected onto a respective cylindrical imaging surface model.

FIG. 12 is a block diagram for applying a virtual pan/tilt for determining a ray incident ray angle based on a virtual incident ray angle.

FIG. 13 is a rotational representation of a pan/tilt between a virtual incident ray angle and a real incident ray angle.

FIG. 14 is a block diagram for displaying the captured images from one or more image captured devices on the rearview mirror display device.

FIG. 15 illustrates a block diagram of a dynamic rearview mirror display imaging system using a single camera.

FIG. 16 illustrates a comparison of FOV for a rear view mirror and an image captured by wide angle FOV camera.

FIG. 17 is a pictorial of the scene output on the image display of the rear view mirror.

FIG. 18 illustrates a block diagram of a dynamic rearview mirror display imaging system that utilizes a plurality of rear facing cameras.

FIG. 19 is a top-down illustration of zone coverage captured by the plurality of cameras.

FIG. 20 is a pictorial of the scene output on the image display of the rear view mirror where image stitching is applied.

FIG. 21 illustrates a block diagram of a dynamic rearview mirror display imaging system that utilizes a two rear facing cameras.

FIG. 22 is a top-down illustration of zone coverage captured by the two cameras.

FIG. 23 is a block diagram of a dynamic forward-view mirror display imaging system that utilizes a plurality of forward facing cameras.

FIG. 24 illustrates a top-down view comparing a FOV as seen by a driver and an image captured by the narrow FOV cameras.

FIG. 25 illustrates a limited FOV of a driver having FOV obstructions.

FIG. 26 illustrates a block diagram of a reconfigurable dynamic rearview mirror display imaging system that utilizes a plurality of surround facing cameras.

FIGS. 27a-d illustrate top-down views of coverage zones for each respective wide FOV cameras.

FIGS. 28a-b illustrate exemplary icons displayed on the display device.

### DETAILED DESCRIPTION

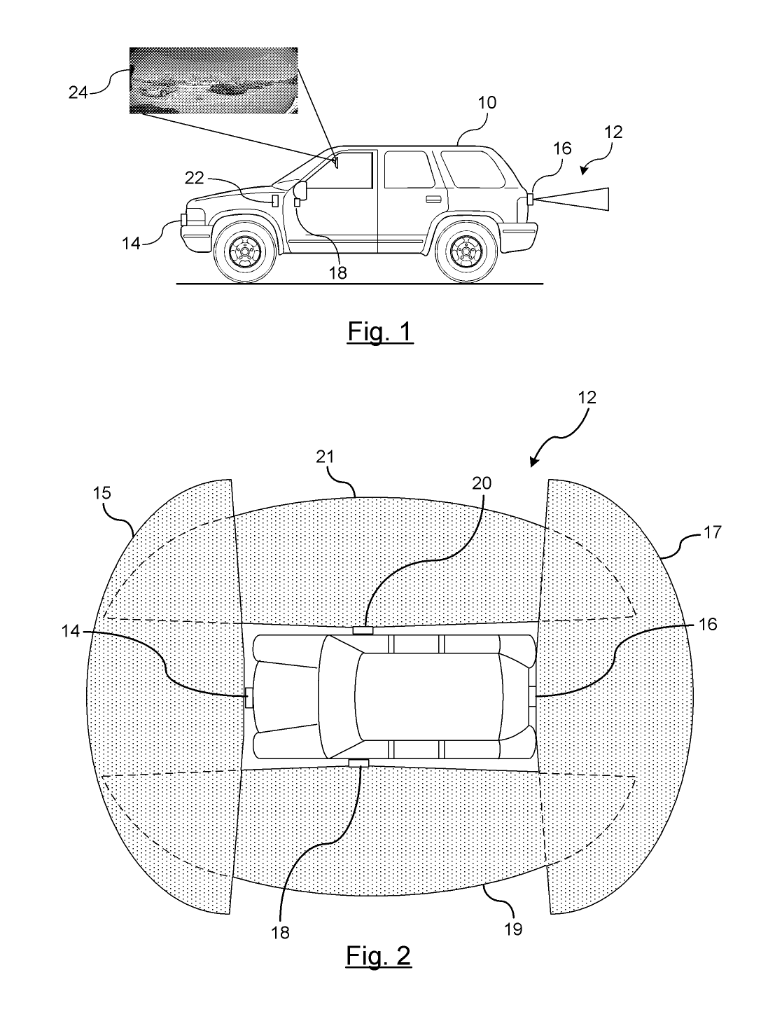

There is shown in FIG. 1, a vehicle 10 traveling along a road. A vision-based imaging system 12 captures images of the road. The vision-based imaging system 12 captures images surrounding the vehicle based on the location of one or more vision-based capture devices. In the embodiments described herein, the vision-based imaging system will be described as capturing images rearward of the vehicle; however, it should also be understood that the vision-based imaging system 12 can be extended to capturing images forward of the vehicle and to the sides of the vehicle.

Referring to both FIGS. 1-2, the vision-based imaging system 12 includes a front-view camera 14 for capturing a field of view (FOV) forward of the vehicle 15, a rear-view camera 16 for capturing a FOV rearward of the vehicle 17, a left-side view camera 18 for capturing a FOV to a left side of the vehicle 19, and a right-side view camera 20 for capturing a FOV on a right side of the vehicle 21. The cameras 14-20 can be any camera suitable for the purposes described herein, many of which are known in the automotive art, that are capable of receiving light, or other radiation, and converting the light energy to electrical signals in a pixel format using, for example, charged coupled devices (CCD). The cameras 14-18 generate frames of image data at a certain data frame rate that can be stored for subsequent processing. The cameras 14-20 can be mounted within or on any suitable structure that is part of the vehicle 10, such as bumpers, facie, grill, side-view mirrors, door panels, etc., as would be well understood and appreciated by those skilled in the art. In one non-limiting embodiment, the side camera 18 is mounted under the side view mirrors and is pointed downwards. Image data from the cameras 14-20 is sent to a processor 22 that processes the image data to generate images that can be displayed on a review mirror display device 24.

The present invention utilizes an image modeling and de-warping process for both narrow FOV and ultra-wide FOV cameras that employs a simple two-step approach and offers fast processing times and enhanced image quality without utilizing radial distortion correction. Distortion is a deviation from rectilinear projection, a projection in which straight lines in a scene remain straight in an image. Radial distortion is a failure of a lens to be rectilinear.

The two-step approach as discussed above includes (1) applying a camera model to the captured image for projecting the captured image on a non-planar surface and (2) applying a view synthesis for mapping the virtual image projected on to the non-planar surface to the real display image. For view synthesis, given one or more images of a specific subject taken from specific points with specific camera setting and orientations, the goal is to build a synthetic image as taken from a virtual camera having a same or different optical axis.

The proposed approach provides effective surround view and dynamic rearview mirror functions with an enhanced de-warping operation, in addition to a dynamic view synthesis for ultra-wide FOV cameras. Camera calibration as used herein refers to estimating a number of camera parameters including both intrinsic and extrinsic parameters. The intrinsic parameters include focal length, image center (or principal point), radial distortion parameters, etc. and extrinsic parameters include camera location, camera orientation, etc.

Camera models are known in the art for mapping objects in the world space to an image sensor plane of a camera to generate an image. One model known in the art is referred to as a pinhole camera model that is effective for modeling the image for narrow FOV cameras. The pinhole camera model is defined as:

$$S \underbrace{[ \begin{matrix}u \\ \begin{matrix}v \\ 1\end{matrix}\end{matrix} ]}_{m} = \underbrace{[ \begin{matrix} & & \\ {f}_{u} & Y & {u}_{c} \\ 0 & {f}_{v} & {v}_{c} \\ 0 & 0 & 1\end{matrix} ]}_{A} \underbrace{[ {r}_{1} {r}_{2} {r}_{3} t ]}_{[ R t ]} \underbrace{[ \begin{matrix}x \\ y \\ z \\ 1\end{matrix} ]}_{M} \qquad ( 1 )$$

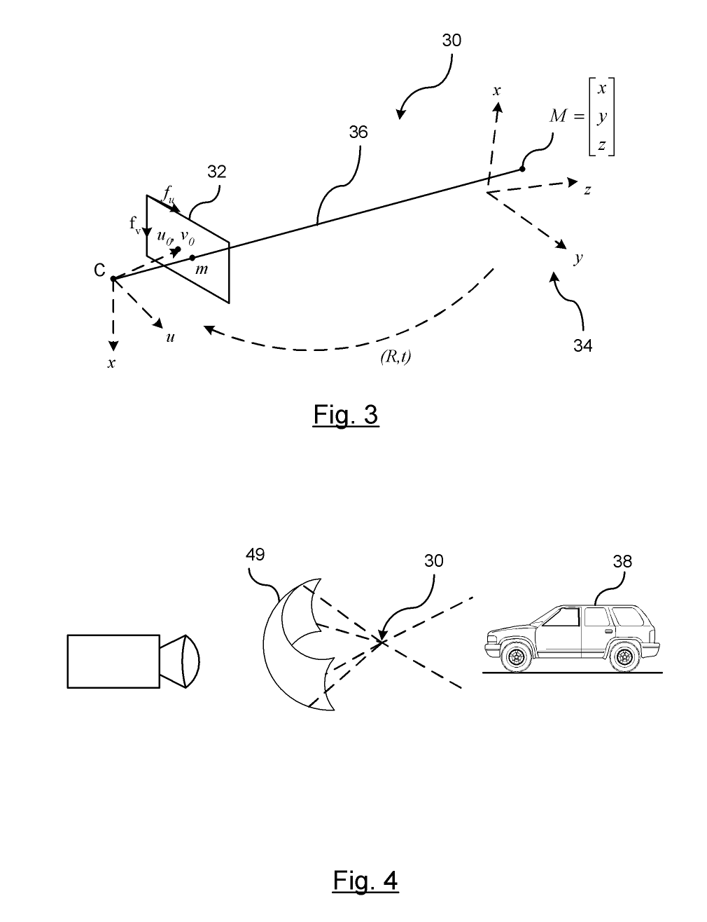

FIG. 3 is an illustration 30 for the pinhole camera model and shows a two dimensional camera image plane 32 defined by coordinates u, v, and a three dimensional object space 34 defined by world coordinates x, y, and z. The distance from a focal point C to the image plane 32 is the focal length f of the camera and is defined by focal length fᵤ and fᵥ. A perpendicular line from the point C to the principal point of the image plane 32 defines the image center of the plane 32 designated by u₀, v₀. In the illustration 30, an object point M in the object space 34 is mapped to the image plane 32 at point m, where the coordinates of the image point m is u_{c}, v_{c}.

Equation (1) includes the parameters that are employed to provide the mapping of point M in the object space 34 to point m in the image plane 32. Particularly, intrinsic parameters include fᵤ, fᵥ, u_{c}, v_{c} and γ and extrinsic parameters include a 3 by 3 matrix R for the camera rotation and a 3 by 1 translation vector t from the image plane 32 to the object space 34. The parameter γ represents a skewness of the two image axes that is typically negligible, and is often set to zero.

Since the pinhole camera model follows rectilinear projection which a finite size planar image surface can only cover a limited FOV range (<<180° FOV), to generate a cylindrical panorama view for an ultra-wide (−180° FOV) fisheye camera using a planar image surface, a specific camera model must be utilized to take horizontal radial distortion into account. Some other views may require other specific camera modeling, (and some specific views may not be able to be generated). However, by changing the image plane to a non-planar image surface, a specific view can be easily generated by still using the simple ray tracing and pinhole camera model. As a result, the following description will describe the advantages of utilizing a non-planar image surface.

The rearview mirror display device 24 (shown in FIG. 1) outputs images captured by the vision-based imaging system 12. The images may be altered images that may be converted to show enhanced viewing of a respective portion of the FOV of the captured image. For example, an image may be altered for generating a panoramic scene, or an image may be generated that enhances a region of the image in the direction of which a vehicle is turning. The proposed approach as described herein models a wide FOV camera with a concave imaging surface for a simpler camera model without radial distortion correction. This approach utilizes virtual view synthesis techniques with a novel camera imaging surface modeling (e.g., light-ray-based modeling). This technique has a variety of applications of rearview camera applications that include dynamic guidelines, 360 surround view camera system, and dynamic rearview mirror feature. This technique simulates various image effects through the simple camera pin-hole model with various camera imaging surfaces. It should be understood that other models, including traditional models, can be used aside from a camera pin-hole model.

FIG. 4 illustrates a preferred technique for modeling the captured scene 38 using a non-planar image surface. Using the pin-hole model, the captured scene 38 is projected onto a non-planar image 49 (e.g., concave surface). No radial distortion correction is applied to the projected image since the images is being displayed on a non-planar surface.

A view synthesis technique is applied to the projected image on the non-planar surface for de-warping the image. In FIG. 4, image de-warping is achieved using a concave image surface. Such surfaces may include, but is not limited to, a cylinder and ellipse image surfaces. That is, the captured scene is projected onto a cylindrical like surface using a pin-hole model. Thereafter, the image projected on the cylinder image surface is laid out on the flat in-vehicle image display device. As a result, the parking space which the vehicle is attempting to park is enhanced for better viewing for assisting the driver in focusing on the area of intended travel.

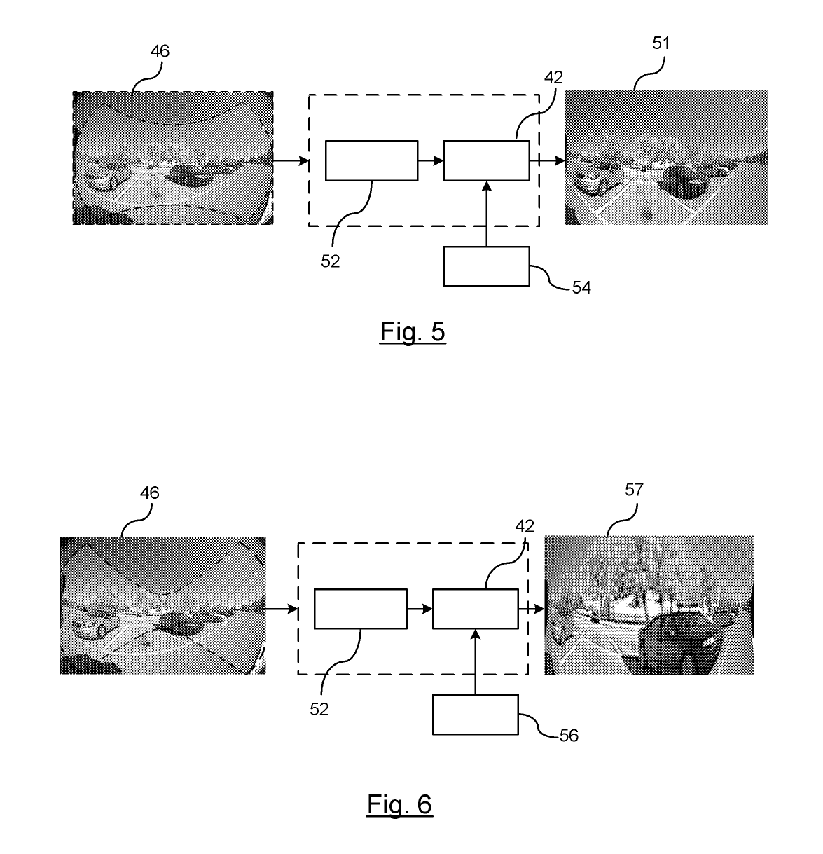

FIG. 5 illustrates a block flow diagram for applying cylinder image surface modeling to the captured scene. A captured scene is shown at block 46. Camera modeling 52 is applied to the captured scene 46. As described earlier, the camera model is preferably a pin-hole camera model, however, traditional or other camera modeling may be used. The captured image is projected on a respective surface using the pin-hole camera model. The respective image surface is a cylindrical image surface 54. View synthesis 42 is performed by mapping the light rays of the projected image on the cylindrical surface to the incident rays of the captured image to generate a de-warped image. The result is an enhanced view of the available parking space where the parking space is centered at the forefront of the de-warped image 51.

FIG. 6 illustrates a flow diagram for utilizing an ellipse image surface model to the captured scene utilizing the pin-hole model. The ellipse image model 56 applies greater resolution to the center of the capture scene 46. Therefore, as shown in the de-warped image 57, the objects at the center forefront of the de-warped image are more enhanced using the ellipse model in comparison to FIG. 6.

Dynamic view synthesis is a technique by which a specific view synthesis is enabled based on a driving scenario of a vehicle operation. For example, special synthetic modeling techniques may be triggered if the vehicle is in driving in a parking lot versus a highway, or may be triggered by a proximity sensor sensing an object to a respective region of the vehicle, or triggered by a vehicle signal (e.g., turn signal, steering wheel angle, or vehicle speed). The special synthesis modeling technique may be to apply respective shaped models to a captured image, or apply virtual pan, tilt, or directional zoom depending on a triggered operation.

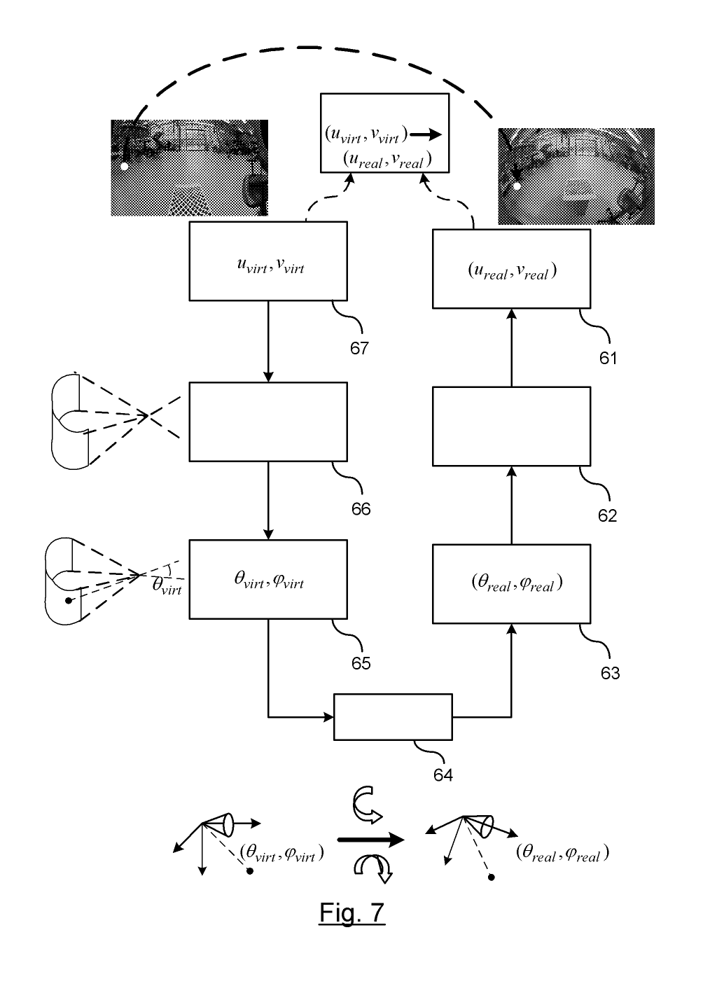

FIG. 7 illustrates a flow diagram of view synthesis for mapping a point from a real image to the virtual image. In block 61, a real point on the captured image is identified by coordinates uᵣₑₐₗ and vᵣₑₐₗ which identify where an incident ray contacts an image surface. An incident ray can be represented by the angles (θ, φ), where θ is the angle between the incident ray and an optical axis, and φ is the angle between the x axis and the projection of the incident ray on the x-y plane. To determine the incident ray angle, a real camera model is pre-determined and calibrated.

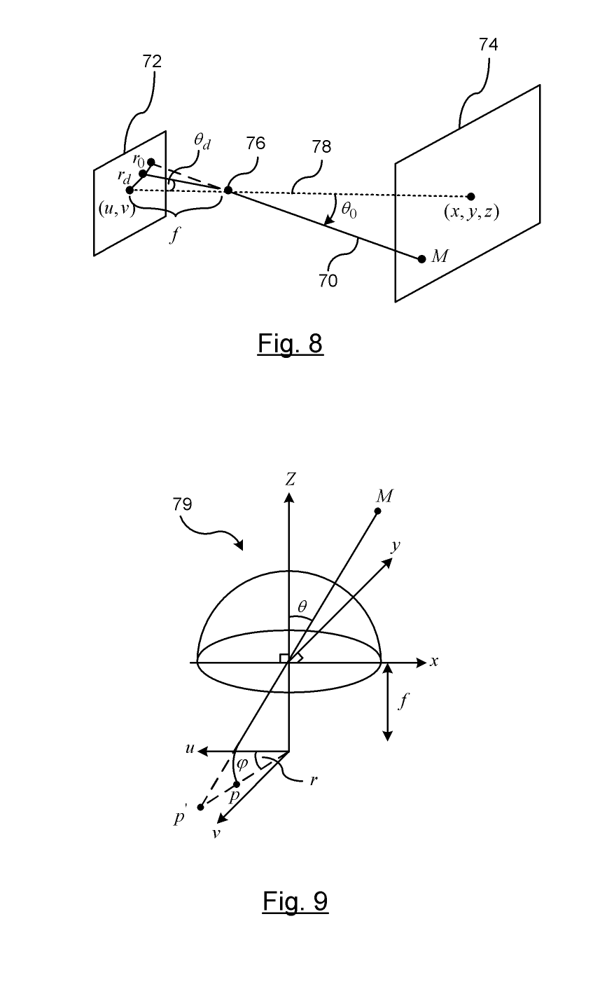

In block 62, the real camera model is defined, such as the fisheye model (r_{d}=func(θ) and φ) and an imaging surface is defined. That is, the incident ray as seen by a real fish-eye camera view may be illustrated as follows:

$$Incident ray -> [ \begin{matrix}\begin{matrix}θ : angle between incident ray \\ and optical axis\end{matrix} \\ \begin{matrix}ϕ : angle between {x}_{c 1} and \\ incident ray projection on \\ the {x}_{c 1} - {y}_{c 1} plane\end{matrix} \\ \end{matrix} ] -> [ \begin{matrix}{r}_{d} = func ( θ ) \\ ϕ\end{matrix} ] -> [ \begin{matrix}{u}_{c 1} = {r}_{d} \cdot cos ( ϕ ) \\ {v}_{c 1} = {r}_{d} \cdot sin ( ϕ )\end{matrix} ] \qquad ( 2 )$$

where u_{c1} represents uᵣₑₐₗ and v_{c1} represents vᵣₑₐₗ. A radial distortion correction model is shown in FIG. 8. The radial distortion model, represented by equation (3) below, sometimes referred to as the Brown-Conrady model, that provides a correction for non-severe radial distortion for objects imaged on an image plane 72 from an object space 74. The focal length f of the camera is the distance between point 76 and the image center where the lens optical axis intersects with the image plane 72. In the illustration, an image location r₀ at the intersection of line 70 and the image plane 72 represents a virtual image point m₀ of the object point M if a pinhole camera model is used. However, since the camera image has radial distortion, the real image point m is at location r_{d}, which is the intersection of the line 78 and the image plane 72. The values r₀ and r_{d} are not points, but are the radial distance from the image center u₀, v₀ to the image points m₀ and m.

r_{d}=r₀(1+k₁·r₀²+k₂·r₀⁴+k₂·r₀⁶+ . . . ) (3)

The point rₒ is determined using the pinhole model discussed above and includes the intrinsic and extrinsic parameters mentioned. The model of equation (3) is an even order polynomial that converts the point r₀ to the point r_{d} in the image plane 72, where k is the parameters that need to be determined to provide the correction, and where the number of the parameters k define the degree of correction accuracy. The calibration process is performed in the laboratory environment for the particular camera that determines the parameters k. Thus, in addition to the intrinsic and extrinsic parameters for the pinhole camera model, the model for equation (3) includes the additional parameters k to determine the radial distortion. The non-severe radial distortion correction provided by the model of equation (3) is typically effective for wide FOV cameras, such as 135° FOV cameras. However, for ultra-wide FOV cameras, i.e., 180° FOV, the radial distortion is too severe for the model of equation (3) to be effective. In other words, when the FOV of the camera exceeds some value, for example, 140°-150°, the value r₀ goes to infinity when the angle θ approaches 90°. For ultra-wide FOV cameras, a severe radial distortion correction model shown in equation (4) has been proposed in the art to provide correction for severe radial distortion.

FIG. 9 illustrates a fisheye model which shows a dome to illustrate the FOV. This dome is representative of a fisheye lens camera model and the FOV that can be obtained by a fisheye model which is as large as 180 degrees or more. A fisheye lens is an ultra wide-angle lens that produces strong visual distortion intended to create a wide panoramic or hemispherical image. Fisheye lenses achieve extremely wide angles of view by forgoing producing images with straight lines of perspective (rectilinear images), opting instead for a special mapping (for example: equisolid angle), which gives images a characteristic convex non-rectilinear appearance This model is representative of severe radial distortion due which is shown in equation (4) below, where equation (4) is an odd order polynomial, and includes a technique for providing a radial correction of the point r₀ to the point r_{d} in the image plane 79. As above, the image plane is designated by the coordinates u and v, and the object space is designated by the world coordinates x, y, z. Further, B is the incident angle between the incident ray and the optical axis. In the illustration, point p′ is the virtual image point of the object point M using the pinhole camera model, where its radial distance r₀ may go to infinity when B approaches 90°. Point p at radial distance r is the real image of point M, which has the radial distortion that can be modeled by equation (4).

The values p in equation (4) are the parameters that are determined. Thus, the incidence angle θ is used to provide the distortion correction based on the calculated parameters during the calibration process.

r_{d}=p₁·θ₀+p₂·θ₀³+p₃·θ₀⁵+ . . . (4)

Various techniques are known in the art to provide the estimation of the parameters k for the model of equation (3) or the parameters p for the model of equation (4). For example, in one embodiment a checker board pattern is used and multiple images of the pattern are taken at various viewing angles, where each corner point in the pattern between adjacent squares is identified. Each of the points in the checker board pattern is labeled and the location of each point is identified in both the image plane and the object space in world coordinates. The calibration of the camera is obtained through parameter estimation by minimizing the error distance between the real image points and the reprojection of 3D object space points.

In block 63, a real incident ray angle (θᵣₑₐₗ) and (φᵣₑₐₗ) are determined from the real camera model. The corresponding incident ray will be represented by a (θᵣₑₐₗ,φᵣₑₐₗ).

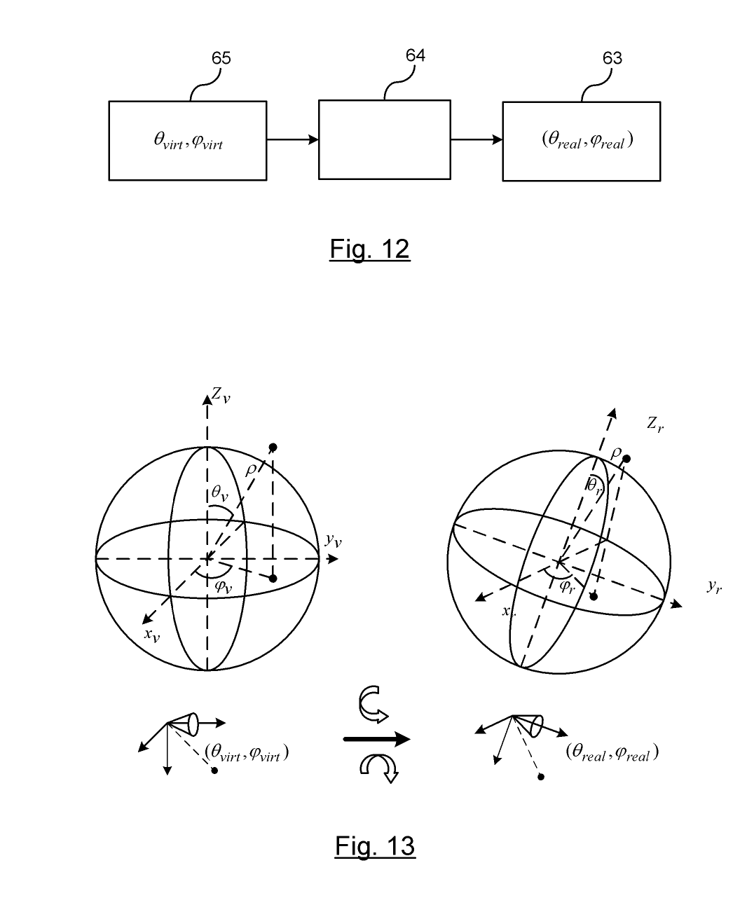

Block 67 represents a conversion process (described in FIG. 12) where a pan and/or tilt condition is present.

In block 65, a virtual incident ray angle θᵥᵢᵣₜ and corresponding φᵥᵢᵣₜ is determined. If there is no virtual tilt and/or pan, then (θᵥᵢᵣₜ, φᵥᵢᵣₜ) will be equal to (θᵣₑₐₗ, φᵣₑₐₗ). If virtual tilt and/or pan are present, then adjustments must be made to determine the virtual incident ray. Discussion of the virtual incident ray will be discussed in detail later.

In block 66, once the incident ray angle is known, then view synthesis is applied by utilizing a respective camera model (e.g., pinhole model) and respective non-planar imaging surface (e.g., cylindrical imaging surface).

In block 67, the virtual incident ray that intersects the non-planar surface is determined in the virtual image. The coordinate of the virtual incident ray intersecting the virtual non-planar surface as shown on the virtual image is represented as (uᵥᵢᵣₜ, vᵥᵢᵣₜ). As a result, a mapping of a pixel on the virtual image (uᵥᵢᵣₜ, vᵥᵢᵣₜ) corresponds to a pixel on the real image (uᵣₑₐₗ, vᵣₑₐₗ).

It should be understood that while the above flow diagram represents view synthesis by obtaining a pixel in the real image and finding a correlation to the virtual image, the reverse order may be performed when utilizing in a vehicle. That is, every point on the real image may not be utilized in the virtual image due to the distortion and focusing only on a respective highlighted region (e.g., cylindrical/elliptical shape). Therefore, if processing takes place with respect to these points that are not utilized, then time is wasted in processing pixels that are not utilized. Therefore, for an in-vehicle processing of the image, the reverse order is performed. That is, a location is identified in a virtual image and the corresponding point is identified in the real image. The following describes the details for identifying a pixel in the virtual image and determining a corresponding pixel in the real image.

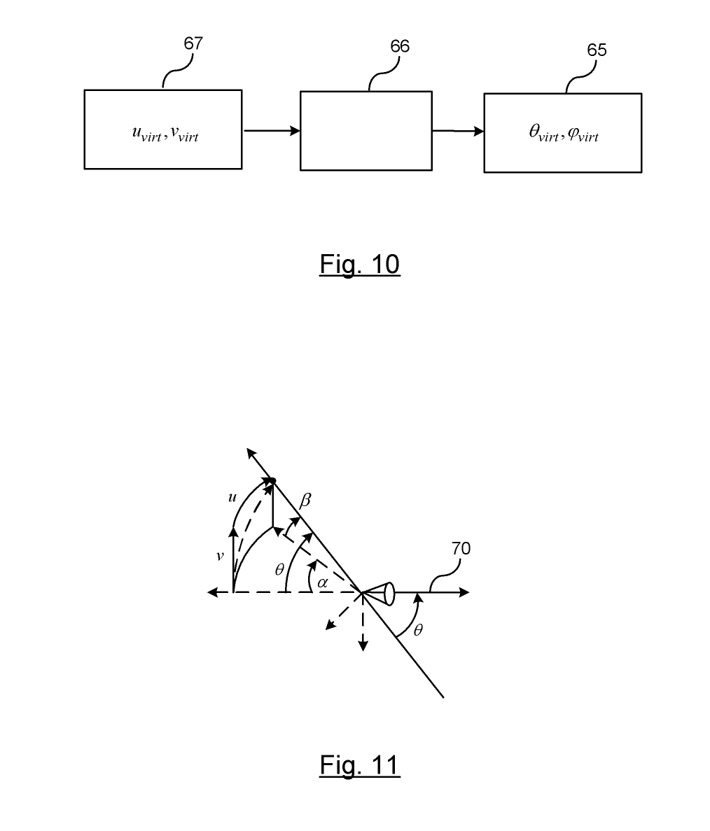

FIG. 10 illustrates a block diagram of the first step for obtaining a virtual coordinate (uᵥᵢᵣₜ vᵥᵢᵣₜ) 67 and applying view synthesis 66 for identifying virtual incident angles (θᵥᵢᵣₜ, φᵥᵢᵣₜ) 65. FIG. 11 represents an incident ray projected onto a respective cylindrical imaging surface model. The horizontal projection of incident angle θ is represented by the angle α. The formula for determining angle α follows the equidistance projection as follows:

$$\frac{{u}_{virt} - {u}_{0}}{{f}_{u}} = α \qquad ( 5 )$$

where uᵥᵢᵣₜ is the virtual image point u-axis (horizontal) coordinate, fᵤ is the u direction (horizontal) focal length of the camera, and u₀ is the image center u-axis coordinate.

Next, the vertical projection of angle θ is represented by the angle β. The formula for determining angle β follows the rectilinear projection as follows:

$$\frac{{v}_{virt} - {v}_{0}}{{f}_{v}} = tan β \qquad ( 6 )$$

where vᵥᵢᵣₜ is the virtual image point v-axis (vertical) coordinate, fᵥ is the v direction (vertical) focal length of the camera, and v₀ is the image center v-axis coordinate.

The incident ray angles can then be determined by the following formulas:

$$\{ \begin{matrix}{θ}_{virt} = arccos ( cos ( α ) \cdot cos ( β ) ) \\ {ϕ}_{virt} = arctan ( sin ( α ) \cdot tan ( β ) )\end{matrix} \} \qquad ( 7 )$$

As described earlier, if there is no pan or tilt between the optical axis 70 of the virtual camera and the real camera, then the virtual incident ray (θᵥᵢᵣₜ, φᵥᵢᵣₜ) and the real incident ray (θᵣₑₐₗ, φᵣₑₐₗ) are equal. If pan and/or tilt are present, then compensation must be made to correlate the projection of the virtual incident ray and the real incident ray.

FIG. 12 illustrates the block diagram conversion from virtual incident ray angles 65 to real incident ray angles 64 when virtual tilt and/or pan 63 are present. FIG. 13 illustrates a comparison between axes changes from virtual to real due to virtual pan and/or tilt rotations. The incident ray location does not change, so the correspondence virtual incident ray angles and the real incident ray angle as shown is related to the pan and tilt. The incident ray is represented by the angles (θ, φ), where θ is the angle between the incident ray and the optical axis (represented by the z axis), and φ is the angle between x axis and the projection of the incident ray on the x-y plane.

For each determined virtual incident ray (θᵥᵢᵣₜ, φᵥᵢᵣₜ), any point on the incident ray can be represented by the following matrix:

$${P}_{virt} = ρ \cdot [ \begin{matrix}sin ( {θ}_{virt} ) \cdot cos ( {θ}_{virt} ) \\ sin ( {θ}_{virt} ) \cdot sin ( {θ}_{virt} ) \\ cos ( {θ}_{virt} )\end{matrix} ] , \qquad ( 8 )$$

where ρ is the distance of the point form the origin.

The virtual pan and/or tilt can be represented by a rotation matrix as follows:

$${R}_{rot} = {R}_{tilt} \cdot {R}_{pam} = [ \begin{matrix}1 & 0 & 0 \\ 0 & cos ( β ) & sin ( β ) \\ 0 & - sin ( β ) & cos ( β )\end{matrix} ] \cdot [ \begin{matrix}cos ( α ) & 0 & - sin ( α ) \\ 0 & 1 & 0 \\ sin ( α ) & 0 & cos ( α )\end{matrix} ] \qquad ( 9 )$$

where α is the pan angle, and β is the tilt angle.

After the virtual pan and/or tilt rotation is identified, the coordinates of a same point on the same incident ray (for the real) will be as follows:

$${P}_{real} = {R}_{rot} \cdot {R}_{virt} = ρ \cdot {R}_{rot} [ \begin{matrix}sin ( {θ}_{virt} ) \cdot cos ( {θ}_{virt} ) \\ sin ( {θ}_{virt} ) \cdot sin ( {θ}_{virt} ) \\ cos ( {θ}_{virt} )\end{matrix} ] = ρ [ \begin{matrix}{a}_{1} \\ {a}_{2} \\ {a}_{3}\end{matrix} ] , \qquad ( 10 )$$

The new incident ray angles in the rotated coordinates system will be as follows:

$${θ}_{real} = arctan ( \frac{\sqrt{{a}_{1}^{2} + {a}_{2}^{2}}}{{a}_{3}} ) , φ = real = arctan ( \frac{{a}_{2}}{{a}_{1}} ) . \qquad ( 11 )$$

As a result, a correspondence is determined between (θᵥᵢᵣₜ, φᵥᵢᵣₜ) and (θᵣₑₐₗ, φᵣₑₐₗ) when tilt and/or pan is present with respect to the virtual camera model. It should be understood that that the correspondence between (θᵥᵢᵣₜ, φᵥᵢᵣₜ) and (θᵣₑₐₗ, φᵣₑₐₗ) is not related to any specific point at distance ρ on the incident ray. The real incident ray angle is only related to the virtual incident ray angles (θᵥᵢᵣₜ, φᵥᵢᵣₜ) and virtual pan and/or tilt angles α and β.

Once the real incident ray angles are known, the intersection of the respective light rays on the real image may be readily determined as discussed earlier. The result is a mapping of a virtual point on the virtual image to a corresponding point on the real image. This process is performed for each point on the virtual image for identifying corresponding point on the real image and generating the resulting image.

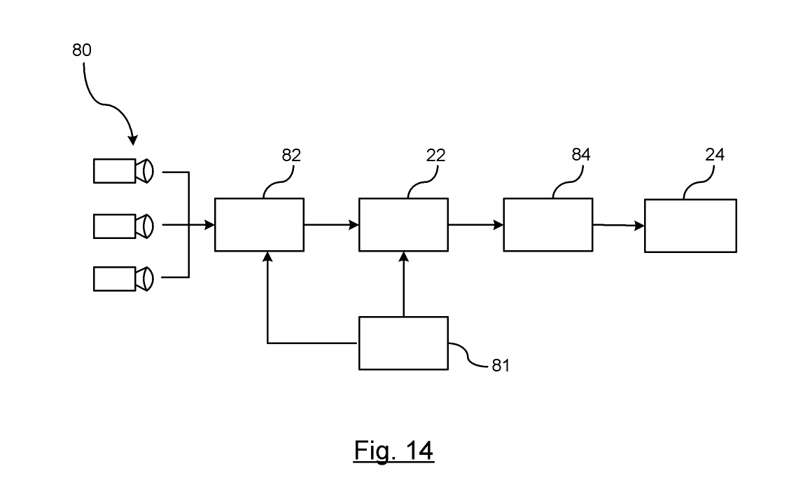

FIG. 14 illustrates a block diagram of the overall system diagrams for displaying the captured images from one or more image capture devices on the rearview mirror display device. A plurality of image capture devices are shown generally at 80. The plurality of image capture devices 80 include at least one front camera, at least one side camera, and at least one rearview camera.

The images captured by the image capture devices 80 are input to a camera switch. The plurality of image capture devices 80 may be enabled based on the vehicle operating conditions 81, such as vehicle speed, turning a corner, or backing into a parking space. The camera switch 82 enables one or more cameras based on vehicle information 81 communicated to the camera switch 82 over a communication bus, such as a CAN bus. A respective camera may also be selectively enabled by the driver of the vehicle.

The captured images from the selected image capture device(s) are provided to a processing unit 22. The processing unit 22 processes the images utilizing a respective camera model as described herein and applies a view synthesis for mapping the capture image onto the display of the rearview mirror device 24.

A mirror mode button 84 may be actuated by the driver of the vehicle for dynamically enabling a respective mode associated with the scene displayed on the rearview mirror device 24. Three different modes include, but are not limited to, (1) dynamic rearview mirror with review cameras; (2) dynamic mirror with front-view cameras; and (3) dynamic review mirror with surround view cameras.

Upon selection of the mirror mode and processing of the respective images, the processed images are provided to the rearview image device 24 where the images of the captured scene are reproduced and displayed to the driver of the vehicle via the rearview image display device 24.

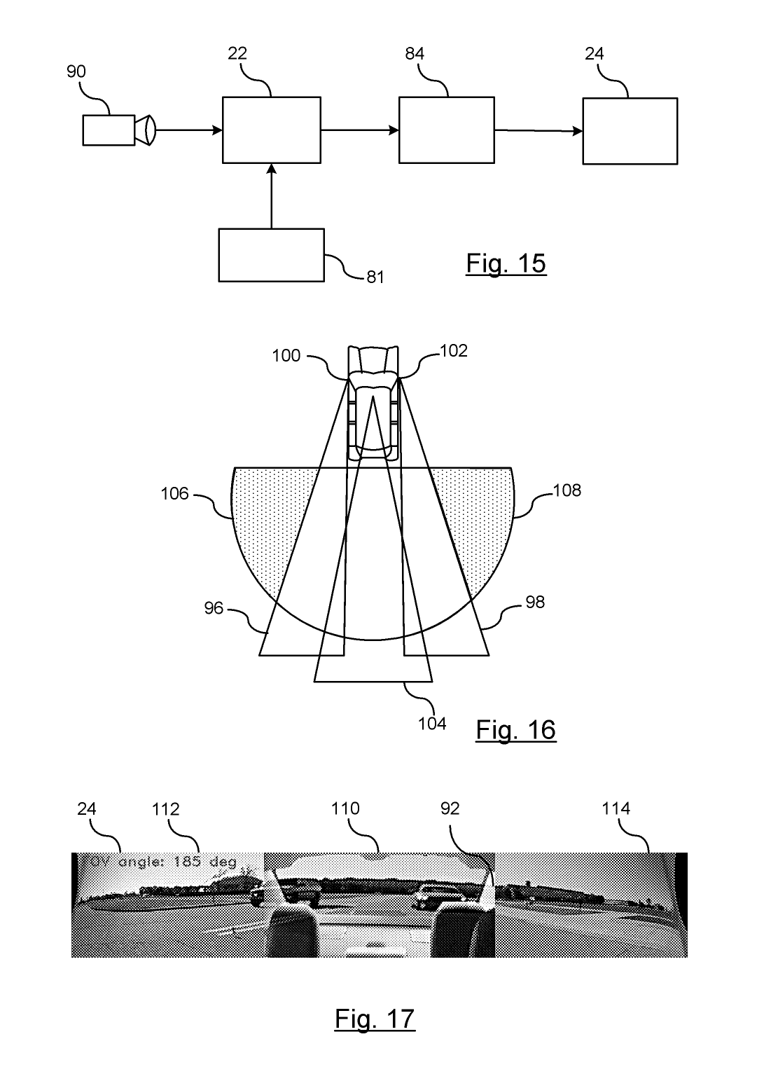

FIG. 15 illustrates a block diagram of a dynamic rearview mirror display imaging system using a single camera. The dynamic rearview mirror display imaging system includes a single camera 90 having wide angle FOV functionality. The wide angle FOV of the camera may be greater than, equal to, or less than 180 degrees viewing angle.

If only a single camera is used, camera switching is not required. The captured image is input to the processing unit 22 where the captured image is applied to a camera model. The camera model utilized in this example includes an ellipse camera model; however, it should be understood that other camera models may be utilized. The projection of the ellipse camera model is meant to view the scene as though the image is wrapped about an ellipse and viewed from within. As a result, pixels that are at the center of the image are viewed as being closer as opposed to pixels located at the ends of the captured image. Zooming of the images are greater at the center of the image as opposed to the sides.

The processing unit 22 also applies a view synthesis for mapping the captured image from the concave surface of the ellipse model to the flat display screen of the rearview mirror.

The mirror mode button 84 includes further functionality that allows the driver to control other viewing options of the rearview mirror display 24. The additional viewing options that may be selected by driver includes: (1) Mirror Display Off; (2) Mirror Display On With Image Overlay; and (3) Mirror Display On Without Image Overlay.

“Mirror Display Off” indicates that the image captured by the capture image device that is modeled, processed, displayed as a de-warped image is not displayed onto the rearview mirror display device. Rather, the rearview mirror functions identical as a mirror displaying only those objects captured by the reflection properties of the mirror.

The “Mirror Display On With Image Overlay” indicates that the captured image by the capture image device that is modeled, processed, and projected as a de-warped image is displayed on the image capture device 24 illustrating the wide angle FOV of the scene. Moreover, an image overlay 92 (shown in FIG. 17) is projected onto the image display of the rearview mirror 24. The image overlay 92 replicates components of the vehicle (e.g., head rests, rear window trim, c-pillars) that would typically be seen by a driver when viewing a reflection through the rearview mirror having ordinary reflection properties. This image overlay 92 assist the driver in identifying relative positioning of the vehicle with respect to the road and other objects surrounding the vehicle. The image overlay 92 is preferably translucent to allow the driver to view the entire contents of the scene unobstructed.

The “Mirror Display On Without Image Overlay” displays the same captured images as described above but without the image overlay. The purpose of the image overlay is to allow the driver to reference contents of the scene relative to the vehicle; however, a driver may find that the image overlay is not required and may select to have no image overlay in the display. This selection is entirely at the discretion of the driver of the vehicle.

Based on the selection made to the mirror button mode 84, the appropriate image is presented to the driver via the rearview mirror in block 24. The mirror button mode 84 may be autonomously actuated by at least one of a switch to mirror display mode only at high speed, a switch to mirror display on with image overlay mode at low speed or in parking, a switch to mirror display on with image overlay mode in parking, a speed adjusted ellipse zooming factor, or a turn signal activated respective view display mode.

FIG. 16 illustrates a top view of the viewing zones that would be seen by a driver using the typical rear viewing devices in comparison to the image captured by wide angle FOV camera. Zones 96 and 98 illustrate the coverage zones that are captured by typical side view mirrors 100 and 102, respectively. Zone 104 illustrates the coverage zone that is captured by the rearview mirror within the vehicle. Zones 106 and 108 illustrate coverage zones that would be captured by the wide angle FOV camera, but not captured by the side view mirrors and rearview mirror. As a result, the image displayed on the rearview mirror that is captured by the image capture device and processed using the camera model and view synthesis provides enhanced coverage that would typically be considered blind spots.

FIG. 17 illustrates a pictorial of the scene output on the image display of the rear view mirror. As is shown in the illustration, the scene provides substantially a 180 degree viewing angle surrounding the rear portion of the vehicle. In addition, the image can be processed such that images in the center portion of the display 110 are displayed at a closer distance whereas images in the end portions 112 and 114 are displayed at a farther distance in contrast to the center portion 110. Based on the demands of the driver or vehicle operations, the display may be modified according to the occurrence of the event. For example, if the objects detected behind the vehicle are closer, then a cylinder camera model may be used. In such a model, the center portion 110 would not be depicted as being so close to the vehicle, and end portion may not be so distant from the vehicle. Moreover, if the vehicle in the process of turning, the camera model could be panned so as to zoom in on an end portion of the image (in the direction that the vehicle is turning) as opposed to the center portion of the image. This could be dynamically controlled based on vehicle information 112 provided to the processing unit 22. The vehicle information can be obtained from various devices of the vehicle that include, but are not limited to, controllers, steering wheel angle sensor, turn signal, yaw sensors, and speed sensors.

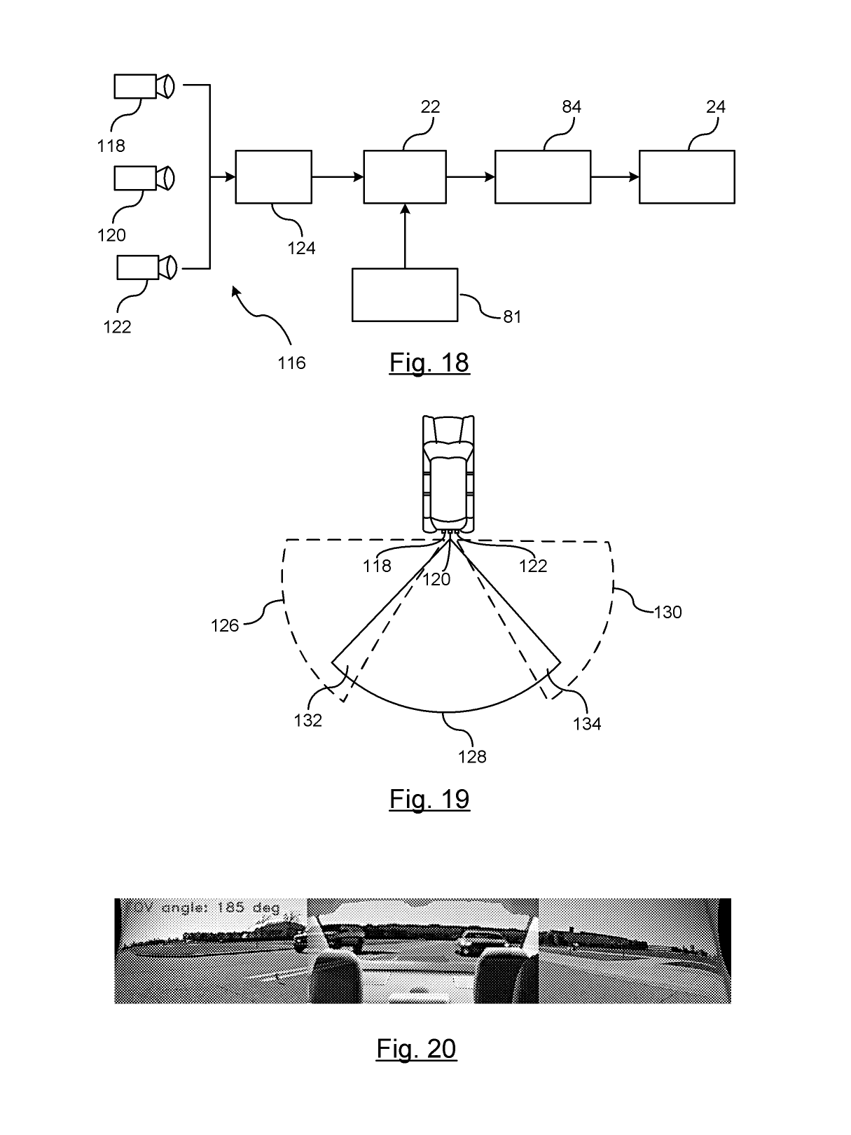

FIG. 18 illustrates a block diagram of a dynamic rearview mirror display imaging system that utilizes a plurality of rear facing cameras 116. The plurality of rear facing cameras 116 are narrow FOV cameras. In the illustration shown, a first camera 118, a second camera 120, and a third camera 122 are spaced a predetermined distance (e.g., 10 cm) from one another for capturing scenes rearward of the vehicle. Cameras 118 and 120 may be angled to capture scenes rearward and to the respective sides of the vehicle. Each of the captured images overlap so that image stitching 124 may be applied to the captured images from the plurality of rear facing cameras 116.

Image stitching 124 is the process of combining multiple images with overlapping regions of the images FOV for producing a segmented panoramic view that is seamless. That is, the combined images are combined such that there is no noticeable boundaries as to where the overlapping regions have been merged. If the three cameras are spaced closely together as illustrated in FIG. 19 with only FOV overlap and negligible position offset, then a simple image registration technique can be used to image stitch the three views together. The simplest implementation is FOV clipping and shifting if the cameras are carefully mounted and adjusted. Another method that produces more accurate results is to find correspondence point pairs set in the overlapped region between two images and register these point pairs to stitch the two images. A same operation applies to the other overlap of the region on the other side. If the three cameras are not spaced closely together but set apart at a distance away, then a stereo vision processing technique may be used to find correspondence in the overlap region between two respective images. The implementation is to calculate the dense disparity map between two views from two cameras and find correspondence where depth information of objects in the overlapped regions can be obtained from the disparity map.

After image stitching 124 has been performed, the stitched image is input to the processing unit 22 for applying camera modeling and view synthesis to the image. The mirror mode button 84 is selected by the driver for displaying the captured image and potentially applying the image overlay to the de-warped image displayed on the rearview mirror 24. As shown, vehicle information may be provided to the processing unit 22 which assists in determining the camera model that should be applied based on the vehicle operating conditions. Moreover, the vehicle information may be used to change a camera pose of the camera model relative to the pose of the vision-based imaging device.

FIG. 19 includes a top-down illustration of zone coverage captured by the plurality of cameras described in FIG. 18. As shown, the first camera 118 captures a narrow FOV image 126, the second camera 120 captures a narrow FOV image 128, and the third camera 122 captures a narrow FOV image 130. As shown in FIG. 19, image overlap occurs between images 128 and 126 as illustrated by 132. Image overlap also occurs between images 128 and 130 as illustrated by 134. Image stitching 122 is applied to the overlapping region to produce a seamless transition between the images which is shown in FIG. 20. The result is an image that is perceived as though the image was captured by a single camera. An advantage of using the three narrow FOV cameras is that a fisheye lens is not required that causes distortion which may result in additional processing to reduce distortion correction.

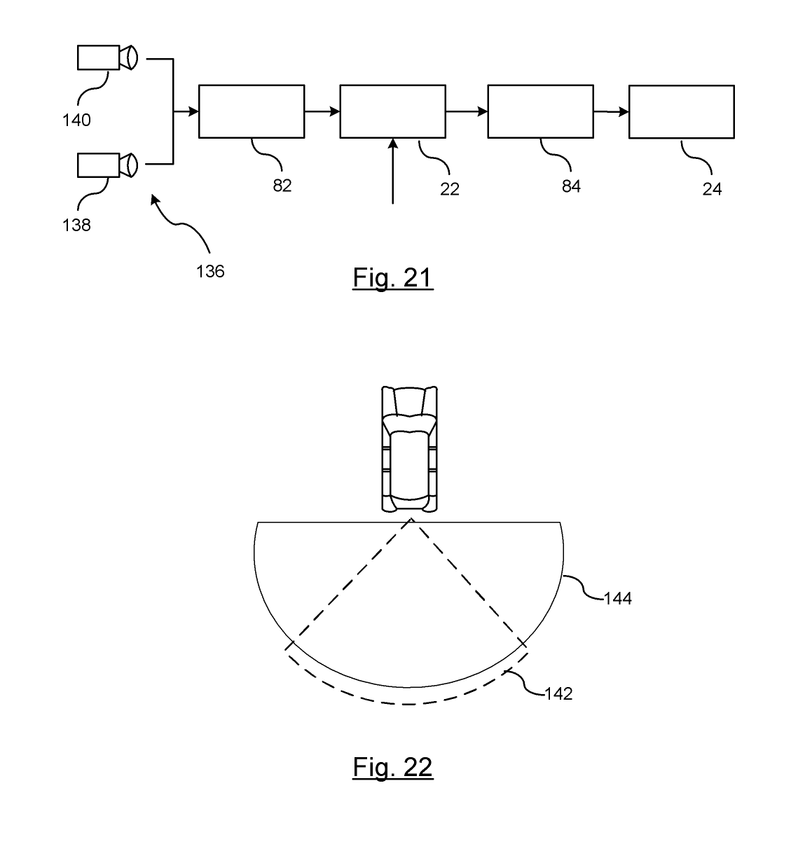

FIG. 21 illustrates a block diagram of a dynamic rearview mirror display imaging system that utilizes a two rear facing cameras 136. The two rear facing cameras include a narrow FOV camera 138 and a wide FOV camera 140. In the illustrations shown, the first camera 138 captures a narrow FOV image and the second camera 140 captures a wide FOV image. As shown in FIG. 22, the first camera 138 (narrow FOV image) captures a center region behind the vehicle. The second camera 140 (wide FOV image) captures an entire surrounding region 144 behind the vehicle. The system includes the camera switch 82, processor 22, mirror mode button 84, and review mirror display 24. If the two cameras have negligible position offset, then a simple image registration technique can be used to image stitch the tow views together. Also, correspondence point pairs set at the overlapping regions of the narrow FOV image and the associated wide FOV image can be identified for registering point pairs for stitching the respective ends of the narrow FOV image within the wide FOV image. The objective is to find corresponding points that match between the two FOV images so that the images can be mapped and any addition warping process can be applied for image stitching the FOV together. It should be understood that other techniques may be applied for identifying correspondence between the two images for merging and image stitching the narrow FOV image and the wide FOV image.

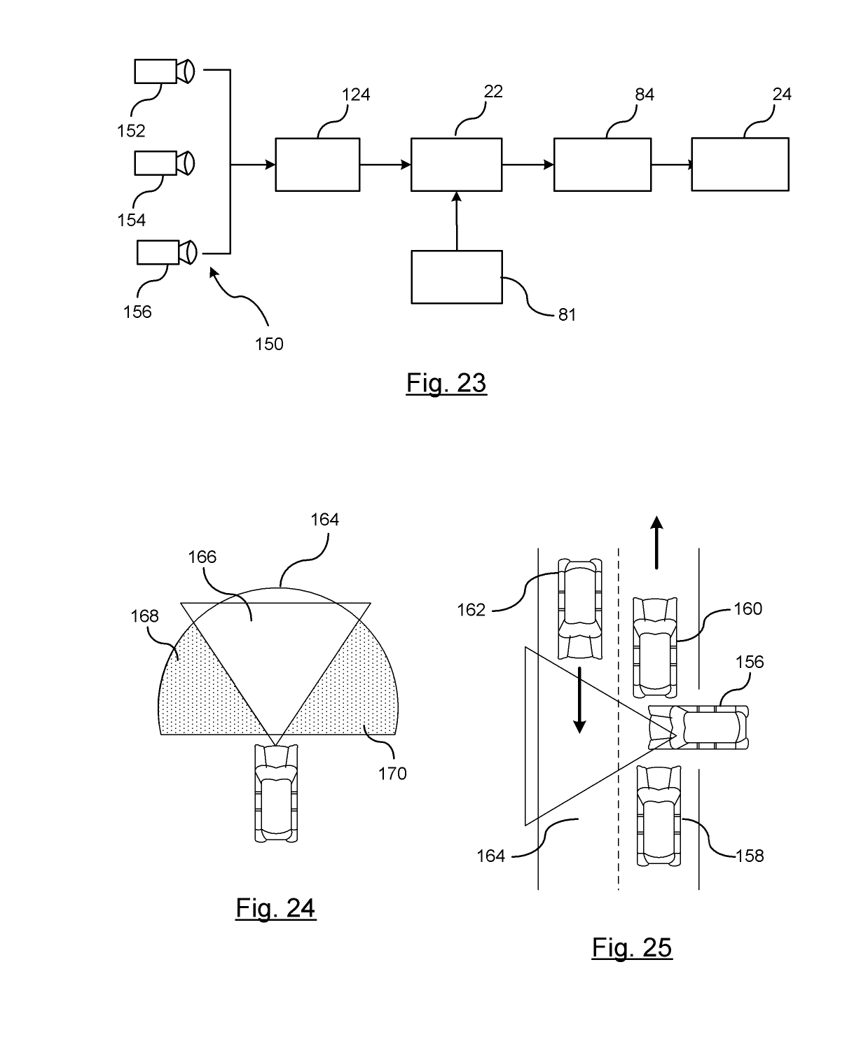

FIG. 23 illustrates a block diagram of a dynamic forward-view mirror display imaging system that utilizes a plurality of forward facing cameras 150. The forward facing cameras 150 are narrow FOV cameras. The illustrations shown, a first camera 152, a second camera 154, and a third camera 156 are spaced a predetermined distance (e.g., 10 cm) from one another for capturing scenes forward of the vehicle. Cameras 152 and 156 may be angled to capture scenes forward and to the respective sides of the vehicle. Each of the captured images overlap so that image stitching 124 may be applied to the captured images from the plurality of forward facing cameras 150.

Image stitching 154 as described earlier is the process of combining multiple images with overlapping regions of the images field of view for producing a segmented panoramic view that is seamless such that there is no noticeable boundaries are present where the overlapping regions have been merged. After image stitching 124 has been performed, the stitched images are input to the processing unit 22 for applying camera modeling and view synthesis to the image. The mirror mode button 84 is selected by the driver for displaying the captured image and potentially applying the image overly to the de-warped image displayed on the rearview mirror. As shown, vehicle information 81 may be provided to the processing unit 22 for determining the camera model that should be applied based on the vehicle operating conditions.

FIG. 24 illustrates a top-down view as seen by a driver in comparison to the image captured by the narrow FOV cameras. This scenario often includes obstructions in the driver's FOV caused by objects to the sides of the vehicle or caused by a vehicle that is directly in front at close range to the vehicle. An example of this is illustrated in FIG. 25. As shown in FIG. 25, a vehicle is attempting to pull out into cross traffic, but due to the proximity and position of the vehicles 158 and 160 on each side of the vehicle 156, obstructions are present in the driver's FOV. As a result, vehicle 162 that is traveling in an opposite direction of vehicles 158 and 160 cannot be seen by the driver. Is such a scenario, vehicle 156 must move the front portion of the vehicle into lane 164 of the cross traffic in order for the driver to obtain a wider FOV of the vehicles approaching in lane 164.

Referring again to FIG. 24, the imaging system provides the driver with a wide FOV (e.g., >180 degrees) 164 and allows the driver to see if any oncoming vehicles are approaching without having to extend a portion of the vehicle into the cross-traffic lane, as opposed to a limited driver FOV 166. Zones 168 and 170 illustrate coverage zones that would be captured by the forward imaging system, but possibly not seen by the driver due to objects or other obstructions. As a result, an image captured by the image capture device and processed using the camera model and view synthesis is displayed on the rearview mirror that provides enhanced coverage that would typically be considered blind spots.

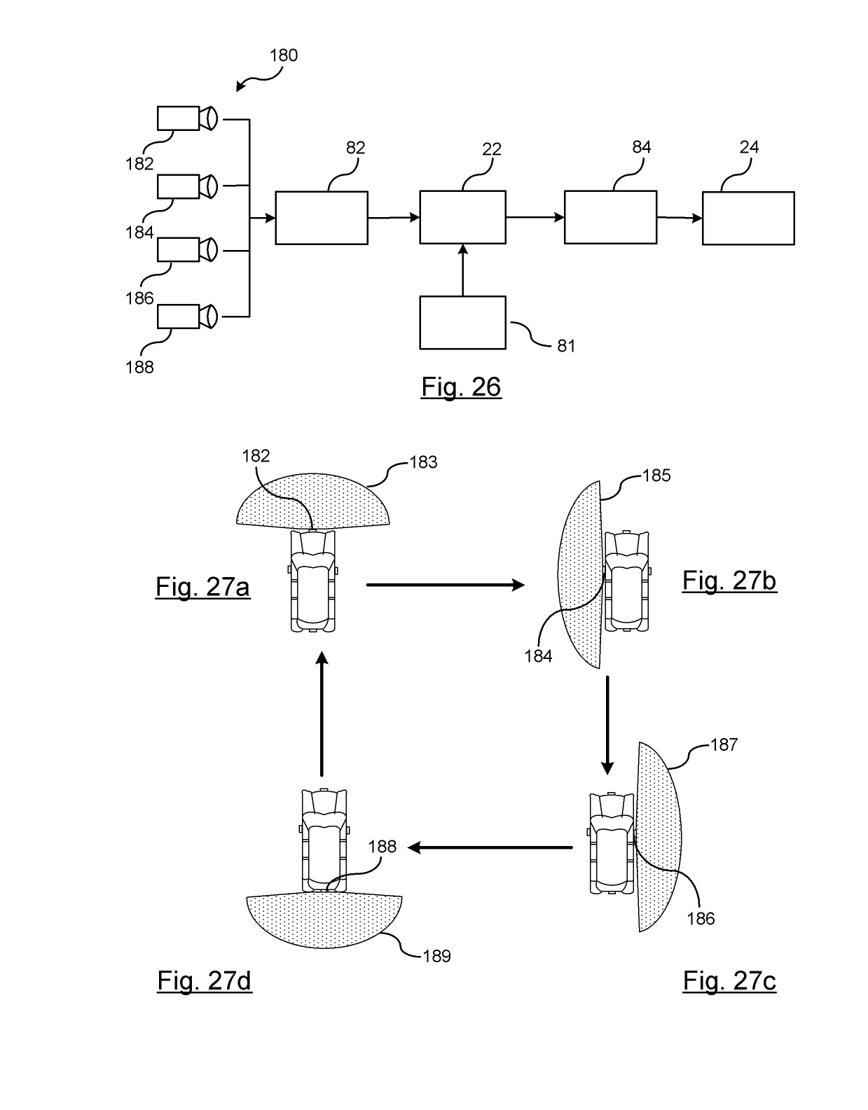

FIG. 26 illustrates a block diagram of a reconfigurable dynamic rearview mirror display imaging system that utilizes a plurality of surround facing cameras 180. As shown in FIGS. 27a-d, each respective camera provide wide FOV image capturing for a respective region of the vehicle. The plurality of surround facing cameras each faces a different side of the vehicle and are wide FOV cameras. In FIG. 27a, a forward facing camera 182 captures wide field of view images in a region forward of the vehicle 183. In FIG. 27b, a left facing camera 184 captures wide field of view images in a region to the left of the vehicle 185 (i.e., driver's side). In FIG. 27c, right side facing camera 186 captures wide field of view images in a region to the right of the vehicle 187 (i.e., passenger's side). In FIG. 27d, rear facing camera 188 captures wide field of view images in a region rear of the vehicle 189.

The captured images by the image capture devices 180 are input to a camera switch 82. The camera switch 82 may be manually actuated by the driver which allows the driver to toggle through each of the images for displaying the image-view of choice. The camera switch 82 may include a type of human machine interface that includes, but is not limited to, a toggle switch, and touch screen application that allows the driver to swipe the screen with finger for scrolling to a next screen, or a voice activated command. As indicated by the arrows in FIG. 27a-d, the driver may selectively scroll through each selection until the desired viewing image is displayed on the review image display screen. Moreover, in response to selecting a respective viewing image, an icon may be displayed on the rearview display device or similar device identifying which respective camera and associated FOV camera is enabled. The icon may be similar to that shown in FIGS. 27a-d, or any other visual icon may be used to indicate to the driver the respective camera associated with the respective location of the vehicle that is enabled.

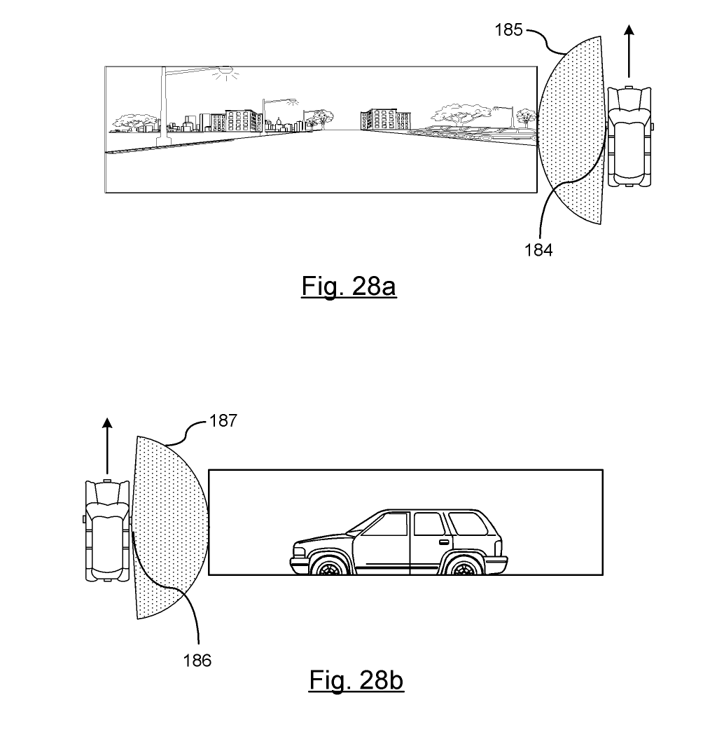

FIG. 28a and FIG. 28b illustrate a rearview mirror device that displays the captured image and an icon representing the view that is being displayed on the rearview display device. As shown in FIG. 28a, an image as captured by a driver-side imaging device is displayed on the rearview display device. The icon representing the left facing camera 184 captures wide field of view images to the left of the vehicle (i.e., drivers side) as represented by the icon 185. The icon is preferably displayed on the rearview display device or similar display device. The benefit of displaying it on the same device displaying the captured image is that that the driver can immediately understand which view the driver is looking at without looking away from the display device. Preferably, the icon is juxtaposed relative to image according to the view that is being displayed. For example, in FIG. 28a, the image represents the view captured on the driver side of the vehicle. Therefore, the image displayed on the rearview display device is located on the driver's side of the icon so that the driver comprehends that the view that is being shown is the same as if the driver is that looking out the driver's side window.

Similarly in FIG. 28b, an image as captured by a passengers-side imaging device is displayed on the rearview display device. The icon representing the right facing camera 186 captures wide field of view images to the right of the vehicle (i.e., passenger's side) as represented by the icon 187. Therefore, the image displayed on the display device is located on the passenger's side of the icon so that the driver comprehends that the view is that looking out the passenger's side window.

Referring again to FIG. 26, the captured images from the selected image capture device(s) are provided to the processing unit 22. The processing unit 22 processes the images from the scene selected by the driver and applies a respective camera model and view synthesis for mapping the capture image onto the display of the rearview mirror device.

Vehicle information 81 may also be applied to either the camera switch 82 or the processing unit 22 that would change the image view or the camera model based on a vehicle operation that is occurring. For example, if the vehicle is turning, the camera model could be panned so as to zoom in an end portion as opposed to the center portion of the image. This could be dynamically controlled based on vehicle information 81 provided to the processing unit 22. The vehicle information can be obtained from various devices of the vehicle that include, but are not limited to, controllers, steering wheel angle sensor, turn signal, yaw sensors, and speed sensors.

The mirror button mode 84 may be actuated by the driver of the vehicle for dynamically enabling a respective mode associated with the scene displayed on the rearview mirror device. Three different modes include, but are not limited to, (1) dynamic rearview mirror with review cameras; (2) dynamic mirror with front-view cameras; and (3) dynamic review mirror with surround view cameras.

Upon selection of the mirror mode and processing of the respective images, the processed images are provided to the rearview image device 24 where the images of the captured scene are reproduced and displayed to the driver of the vehicle via the rearview image display device.

While certain embodiments of the present invention have been described in detail, those familiar with the art to which this invention relates will recognize various alternative designs and embodiments for practicing the invention as defined by the following claims.

1. A method for displaying a captured image on a display device comprising the steps of:
capturing a scene by an at least one vision-based imaging device;
generating a virtual image of the captured scene by a processor using a camera model;
applying a view synthesis technique to the captured image by the processor for generating a de-warped virtual image;
actuating a dynamic rearview mirror display mode for enabling a viewing mode of the de-warped image on the rearview mirror display device; and
displaying the de-warped image in the enabled viewing mode on the rearview mirror display device.

2. The method of claim 1 wherein multiple images are captured by a plurality of image capture devices that include different viewing zones exterior of the vehicle, the multiple images having overlapping boundaries for generating a panoramic view of an exterior scene of the vehicle, wherein the method further comprises the steps of:
prior to camera modeling, applying image stitching to each of the multiple images captured by the plurality of the image capture devices, the image stitching combining the multiple images within for generating a seamless transition between the overlapping regions of the multiple images.

3. The method of claim 2 wherein the image stitching includes clipping and shifting of the overlapping regions of the respective image for generating the seamless transition.

4. The method of claim 2 wherein image stitching includes identifying corresponding points pair sets in the overlapping region between two respective images and registering the corresponding point pairs for stitching the two respective images.

5. The method of claim 2 wherein image stitching includes a stereo vision processing technique applied to find correspondence in the overlapping region between two respective images.

6. The method of claim 2 wherein the plurality of image capture devices include three narrow field-of-view image capture devices each capturing a different respective field-of-view scene, wherein each set of adjacent field-of-views scenes includes overlapping scene content, and wherein image stitching is applied to the overlapping scene content of each set of adjacent field-of-view scenes.

7. The method of claim 6 wherein the imaging stitching applied to the three narrow field-of-views generates a panoramic scene of approximately 180 degrees.

8. The method of claim 6 wherein each of the plurality of image capture devices are rear facing image capture devices.

9. The method of claim 6 wherein each of the plurality of image capture devices are forward facing image capture devices.

10. The method of claim 6 wherein vehicle information relating to vehicle operating conditions are communicated to a camera switch for selectively enabling and disabling image capture devices based on the vehicle operating conditions.

11. The method of claim 6 wherein image capture devices are enabled and disabled based on a driver selectively enabling or disabling a respective image capture device.

12. The method of claim 2 wherein the plurality of image capture devices includes a narrow field-of-view image capture device and a wide field-of-view image capture device, the narrow field-of-view image capture device capturing a narrow field-of-view scene, the wide field-of-view image capture device capturing a wide field-of-view scene of substantially 180 degrees, wherein the narrow field-of-view captured scene is a subset of the wide field-of-view captured scene for enhancing an overlapping field-of-view, wherein correspondence point pairs sets at overlap region of the narrow field-of-view scene and associated wide field-of-view scene are identified for registering point pair used to image stitch the narrow field-of-view scene and the wide field-of-view scene.

13. The method of claim 2 wherein the plurality of image capture devices includes a plurality of vehicle surround facing image capture devices disposed on different sides of the vehicle, wherein the plurality of surround facing capture image devices include a forward facing camera for capturing images forward of the vehicle, a rearward facing camera for capturing images rearward of the vehicle, right side facing camera for capturing images on a right side of the vehicle, and a left side facing camera for capturing images on a left side of the vehicle, wherein a respective image is displayed on the rearview mirror display device.

14. The method of claim 13 wherein image capture devices are selectively enabled and disabled based on communicating vehicle information relating to vehicle operating conditions to a camera switch.

15. The method of claim 14 wherein a visual icon is actuated representing a current view being captured by the enabled image capture device.

16. The method of claim 13 wherein image capture devices are enabled and disabled based on a driver selectively enabling or disabling a respective image capture device.

17. The method of claim 1 wherein enabling a viewing mode is selected from one of a mirror display mode, a mirror display on with image overlay mode, and mirror display on without image overlay mode, wherein the mirror display mode projects no image on the rearview display mirror, wherein the mirror display on with image overlay mode projects the generated de-warped image and an image overlay replicating interior components of the vehicle, and wherein the mirror display without image overlay mode displays only the generated de-warped image.

18. The method of claim 17 wherein selecting the mirror display on with image overlay mode for generating an image overlay replicating interior component of the vehicle includes replicating at least one of a head rest, rear window trim, and c-pillars in the rearview mirror display device.

19. The method of claim 17 wherein a rearview mirror mode button is actuated by a driver for selecting one of the respective captured images for display on the rearview mirror display device.

20. The method of claim 17 wherein a rearview mirror mode button is actuated by at least one of mirror display mode only at high speed, a mirror display on with image overlay mode at low speed or in parking, a mirror display on with image overlay mode in parking, a speed adjusted ellipse zooming factor, a turn signal activated respective view display mode.

21. The method of claim 17 wherein image capture devices and viewing mode are selectively enabled and disabled based on communicating vehicle information relating to vehicle operating conditions to a camera switch.

22. The method of claim 21 wherein the vehicle information is obtained from one of a plurality devices that include steering wheel angle sensors, turn signals, yaw sensors, and speed sensors.

23. The method of claim 21 wherein the vehicle information is used to change a camera pose of the camera model relative to the pose of the vision-based imaging device.

24. The method of claim 1 wherein the view synthesis technique for generating the virtual image is enabled based on a driving scenario of a vehicle operation, wherein the dynamic view synthesis generates a direction zoom to a region of the image for enhancing visual awareness to a driver for the respective region.

25. The method of claim 24 wherein the driving scenario of a vehicle operation for enabling the dynamic view synthesis includes determining whether the vehicle is driving in a parking lot.

26. The method of claim 24 wherein the driving scenario of a vehicle operation for enabling the dynamic view synthesis includes determining whether the vehicle is driving in on highway.

27. The method of claim 24 wherein the driving scenario of a vehicle operation for enabling the dynamic view synthesis includes actuating a turn signal.

28. The method of claim 24 wherein the driving scenario of a vehicle operation for enabling the dynamic view synthesis is based on a steering wheel angle.

29. The method of claim 24 wherein the driving scenario of a vehicle operation for enabling the dynamic view synthesis is based on a speed of the vehicle.
